(19) United States
(12) Patent Application Publication
(10) Pub. No.: US 2017/0057539 A1
(43) Pub. Date: Mar. 2, 2017

(54) STEERING COLUMN FOR VEHICLE

(71) Applicant: MANDO CORPORATION, Pyeongtaek-si (KR)

(72) Inventors: Jong Han Kim, Seoul (KR); Hong Yong BHAE, Yongin-si (KR)

(21) Appl. No.: 15/254,776

(22) Filed: Sep. 1, 2016

(30) Foreign Application Priority Data
Sep. 1, 2015 (KR) 10-2015-0123767

(51) Int. Cl. B62D 3/04; F16H 55/22

(52) U.S. Cl. CPC B62D 3/04; F16H 55/22

(57) ABSTRACT

The present disclosure relates to a steering column for a vehicle. The present disclosure provides a steering column for a vehicle that includes: an input shaft connected with a steering wheel at one end portion thereof, wherein a torque sensor is coupled to the outer circumferential surface of the input shaft; an output shaft having a worm wheel coupled to the outer circumferential surface of one end portion thereof that is connected with an opposite end portion of the input shaft; an output shaft bearing coupled to the outer circumferential surface of the output shaft so as to be located adjacent to the worm wheel; and a support member interposed between the outside of the outer race of the output shaft bearing and a gear housing to support the output shaft bearing in the radial direction.

### CROSS REFERENCE TO RELATED APPLICATION

This application claims priority from Korean Patent Application No. 10-2015-0123767, filed on Sep. 1, 2015, which is hereby incorporated by reference for all purposes as if fully set forth herein.

### BACKGROUND OF THE INVENTION

1. Field of the Invention

The present invention relates to a steering column for a vehicle. More specifically, the present invention relates to a steering column for a vehicle that can enhance the precision of a sensor in the positions to which a worm shaft, a worm wheel, a torque sensor, and the like are coupled, and can reduce the total volume and weight while preventing bearings from being deformed and damaged by impacts transmitted to input and output shafts.

2. Description of the Prior Art

In general, a steering apparatus for a vehicle uses a power steering system as an auxiliary power device in order to reduce a driver's force. The power steering system is broadly divided into a hydraulic power steering system that uses hydraulic pressure that assists with a steering force by operating a hydraulic pump using the force of an engine and an electric power steering system that uses an electric motor.

A hydraulic power steering system assists with a driver's steering force by detecting the rotation of a steering wheel, operating a hydraulic pump using a rotational force transmitted from an engine, and transmitting hydraulic pressure to a driving unit, such as a cylinder, which is provided on a rack bar or a steering column.

An electric power steering system enables a steering apparatus to effectively operate by detecting the rotation of a steering wheel and operating a motor that is installed on a rack or a steering column to assist with a rotary motion. An electric power steering system is divided into a rack assist type electric power steering system (R-EPS) and a column type electric power steering system (C-EPS).

The following description will be given on the basis of an electric power steering system.

FIG. 1 is a schematic view illustrating a steering apparatus of a vehicle in the related art, and FIG. 2 is a partially sectioned view illustrating a steering column of the vehicle in the related art.

As illustrated in the drawings, the steering apparatus of the vehicle in the related art includes a steering system 100 that extends from a steering wheel 101 to wheels 108 and an auxiliary power device 120 that provides auxiliary steering power for the steering system 100.

The steering system 100 includes a steering column 102 that is connected, at one side thereof, to the steering wheel 101 to rotate together with the steering wheel 101 and is connected, at the opposite side thereof, to a pinion shaft 104 through a pair of universal joints 103.

The pinion shaft 104 is connected to a rack bar through a rack-pinion mechanism 105, and the opposite ends of the rack bar are connected to the wheels 108 of the vehicle through tie rods 106 and knuckle arms 107. The rack-pinion mechanism 105 is constituted by a pinion gear 111 and a rack gear 112 that are engaged with each other, in which the pinion gear 111 is formed on the pinion shaft 104 and the rack gear 112 is formed on one side of the outer circumferential surface of the rack bar. When a driver operates the steering wheel 101, a torque is generated in the steering system 100, and the wheels 108 are turned by the torque through the rack-pinion mechanism 105 and the tie rods 106.

The auxiliary power device 120 includes a torque sensor 125 that senses the torque applied to the steering wheel 101 by a driver and outputs an electrical signal proportional to the detected torque, an Electronic Control Unit (ECU) 123 that generates a control signal on the basis of the electrical signal transmitted from the torque sensor, a motor 130 that generates auxiliary power on the basis of the signal transmitted from the electronic control unit 123, and a speed reducer 140 constituted by a worm wheel 141 and a worm shaft 143 that transmit the auxiliary power generated by the motor to the steering column 102.

The steering column includes a lower steering column 210 coupled to an input shaft 215 by a pin 225 and an upper steering column 205 coupled with the lower steering column 210. The lower and upper steering columns are coupled to be aligned with each other with respect to the same central axis. The upper steering column 205 is connected with the steering wheel (not illustrated) and the input shaft 215 is press-fit into an output shaft 220 such that the steering column may transmit the steering force of the steering wheel.

The lower end portion of the lower steering column 210 is inserted into the input shaft 215 and is coupled with the input shaft 215 and a torsion bar 230 by the pin 225, and the upper end portion of the lower steering column 210 is coupled with the upper steering column 205 by engaging a serration 235 formed on the outer circumferential surface of the upper end portion with a serration 235 formed on the inner circumferential surface of the upper steering column 205 and simultaneously performing plastic molding on the serrations 235.

The steering column of the vehicle in the related art has a problem in that the portions of the input and output shafts to which the worm shaft, the worm wheel, the torque sensor, and the like for providing an auxiliary steering force input from the motor are coupled oscillate in the right positions, or deviate from the right positions, so that it is difficult to perform an accurate sensing operation of a sensor and to provide an accurate auxiliary steering force.

In addition, due to the structure of the steering column, it is difficult to change the position of the auxiliary power device coupled to the steering column and to reduce the volume of the auxiliary power device. Accordingly, it is required to reduce the volume and weight of the steering column.

### SUMMARY OF THE INVENTION

In this background, an aspect of the present invention is to provide a steering column for a vehicle that can enhance the precision of a sensor in the positions to which a worm shaft, a worm wheel, a torque sensor, and the like for providing an auxiliary steering force input from a motor are coupled, and can reduce the total volume and weight without oscillation or deviation of input and output shafts in the right positions by preventing bearings from being deformed and damaged by impacts transmitted to the input and output shafts.

Furthermore, the aspect of the present invention is not limited thereto, and other unmentioned aspects of the present invention may be clearly appreciated from the following descriptions by those skilled in the art.

In accordance with an aspect of the present invention, there is provided a steering column for a vehicle. The steering column includes: an input shaft connected with a steering wheel at one end portion thereof, wherein a torque sensor is coupled to the outer circumferential surface of the input shaft; an output shaft having a worm wheel coupled to the outer circumferential surface of one end portion thereof that is connected with an opposite end portion of the input shaft; an output shaft bearing coupled to the outer circumferential surface of the output shaft so as to be located adjacent to the worm wheel; and a support member interposed between the outside of the outer race of the output shaft bearing and a gear housing to support the output shaft bearing in the radial direction.

As described above, according to the present invention, it is possible to enhance the precision of a sensor in the positions to which the worm shaft, the worm wheel, the torque sensor, and the like for providing an auxiliary steering force input from the motor are coupled, and it is possible to reduce the total volume and weight without oscillation or deviation of the input and output shafts in the right positions by preventing the bearings from being deformed and damaged by impacts transmitted to the input and output shafts.

### BRIEF DESCRIPTION OF THE DRAWINGS

20

The above and other objects, features, and advantages of the present invention will be more apparent from the following detailed description taken in conjunction with the accompanying drawings, in which:

FIG. 1 is a schematic view illustrating a steering system of a vehicle in the related art.

FIG. 2 is a partially sectioned view illustrating a steering column of the vehicle in the related art.

FIG. 3 is an exploded perspective view illustrating a part of a steering column of a vehicle according to the present invention.

FIGS. 4 and 5 are perspective views illustrating a part of the steering column of the vehicle according to the present invention.

FIG. 6 is a partially sectioned view illustrating a part of the steering column of the vehicle according to the present invention.

### DETAILED DESCRIPTION OF THE EXEMPLARY EMBODIMENTS

Hereinafter, embodiments of the present invention will be described in detail with reference to the accompanying drawings. In adding reference numerals to elements in each drawing, the same elements will be designated by the same reference numerals, if possible, although they are shown in different drawings. Further, in the following description of the present invention, a detailed description of known functions and configurations incorporated herein will be omitted when it is determined that the description may make the subject matter of the present invention rather unclear.

In addition, terms, such as first, second, A, B, (a), (b) or the like may be used herein when describing components of the present invention. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

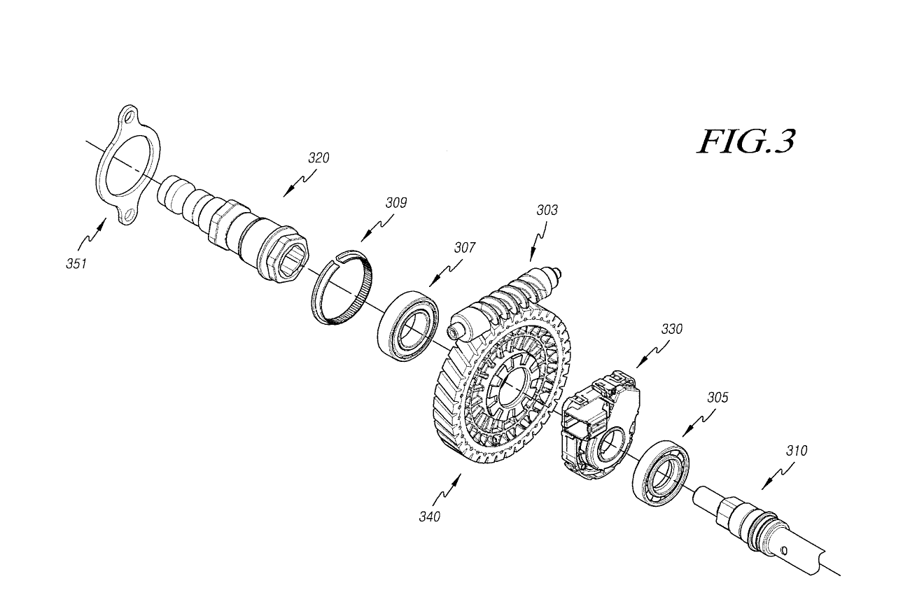

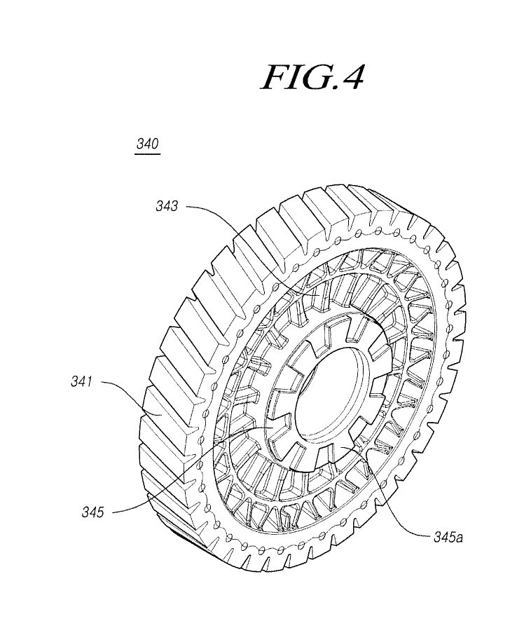

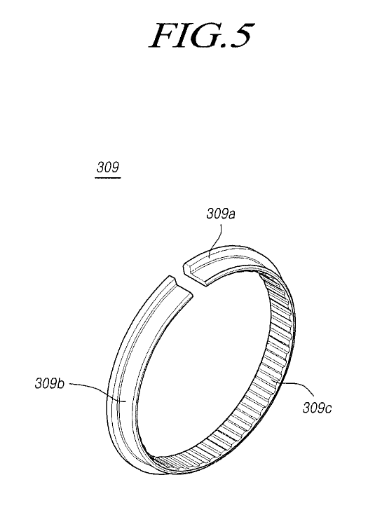

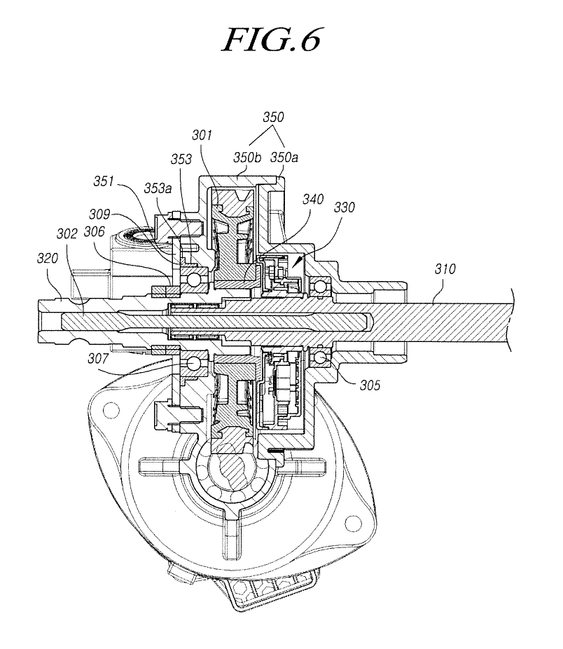

FIG. 3 is an exploded perspective view illustrating a part of a steering column of a vehicle according to the present invention. FIGS. 4 and 5 are perspective views illustrating a part of the steering column of the vehicle according to the present invention. FIG. 6 is a partially sectioned view illustrating a part of the steering column of the vehicle according to the present invention.

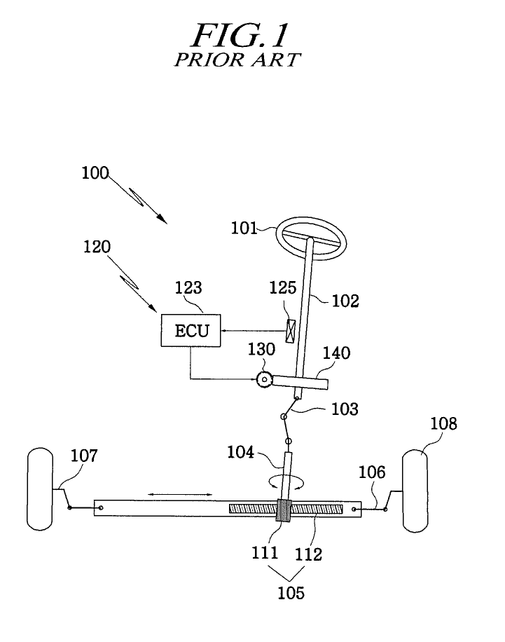

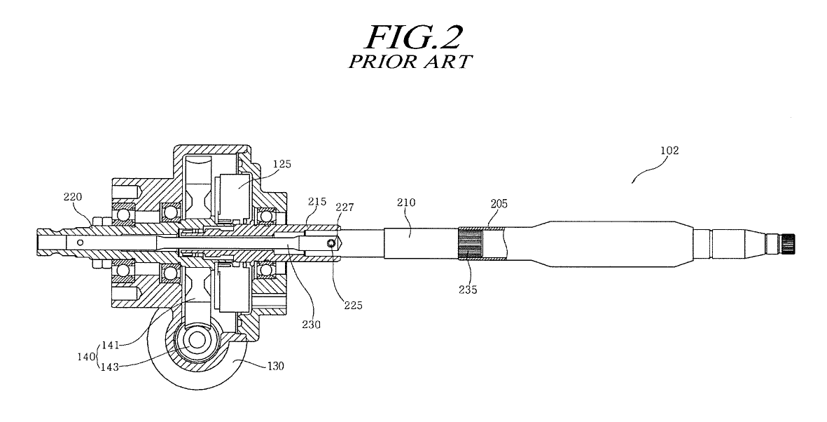

As illustrated in the drawings, the steering column of the vehicle, according to the present invention, includes: an input shaft 310 connected with a steering wheel (see reference numeral 101 of FIG. 1) at one end portion thereof and having a torque sensor 330 coupled to the outer circumferential surface thereof; an output shaft 320 having a worm wheel 340 coupled to the outer circumferential surface of one end portion thereof that is connected with the opposite end portion of the input shaft 310; an output shaft bearing 307 coupled to the outer circumferential surface of the output shaft 320 so as to be located adjacent to the worm wheel 340; and a support member 309 interposed between the outside of the outer race of the output shaft bearing 307 and a gear housing 350 to support the output shaft bearing 307 in the radial direction.

The torque sensor 330 coupled to the outer circumferential surface of the input shaft 310 measures a torque generated when a driver operates the steering wheel, and the input shaft 310 connected with the steering wheel transmits an auxiliary steering force to the output shaft 320 through an auxiliary power device.

Here, the auxiliary power device includes: the torque sensor 330 that senses a torque when a driver operates the steering wheel and outputs an electrical signal proportional to the detected torque; an electronic control unit (not illustrated) that generates a control signal on the basis of the electrical signal transmitted from the torque sensor 330; a motor that generates auxiliary power on the basis of the control signal transmitted from the electronic control unit, and a worm shaft 303 and the worm wheel 340 that transmit the auxiliary power generated by the motor to the output shaft 320.

The input shaft 310 is connected with the steering wheel at one end portion thereof, and the torque sensor 330 is coupled to the outer circumferential surface of the input shaft 310. One end portion of the output shaft 310 is connected with the opposite end portion of the input shaft 310, and the opposite end portion of the output shaft 310 is connected to a pinion shaft through universal joints (see reference numeral 103 of FIG. 1). A torsion bar 302 is connected to the insides of the input and output shafts 310 and 320 at opposite end portions thereof.

The worm wheel 340 is coupled to the outer circumferential surface of one end portion of the output shaft 320 that is connected with the opposite end portion of the input shaft 310, and protrusions 345a are formed on one end of the central portion of the worm wheel 340, which is directed toward the torque sensor 330, in the radial direction so as to face the torque sensor 330 in the axial direction such that the torque sensor 330 may sense a change in the positions of the protrusions 345a that face protrusions (not illustrated) of a transmission unit embedded in the torque sensor 330.

Accordingly, the worm wheel 340 transmits the auxiliary steering force generated by the motor to the output shaft 320 while rotating in conjunction with the output shaft 320, and the torque sensor 330 senses a torque using a change in the positions of the protrusions 345a, which are formed on the worm wheel 340, relative to the torque sensor 330.

The worm wheel 340 includes: a gear-formed portion 341 in which a gear engaged with the worm shaft 303 is formed; an annular hub 345 provided on the central portion thereof; and a boss 343 constituted by a plurality of radial and circumferential ribs that connect the hub 345 and the gear-formed portion 341. The gear-formed portion 341 and the boss 343 may be integrally formed with the metal hub 345 having the protrusions 345a through injection molding using a plastic resin. Alternatively, the hub having the protrusions 345a may be separately manufactured and then coupled to the boss.

The output shaft bearing 307 is coupled to the outer circumferential surface of the output shaft 320 so as to be located adjacent to the worm wheel 340, and an input shaft bearing 305 is coupled to the outer circumferential surface of the input shaft 310 so as to be located adjacent to the torque sensor 330.

The support member 309 is interposed between the outside of the outer race of the output shaft bearing 307 and the gear housing 350 to support the output shaft bearing 307 in the radial direction, and the outer race of the output shaft bearing 307 and the support member 309 are axially supported by a bearing bracket 351 coupled to the outside of the gear housing 350, which makes it possible to prevent the output shaft bearing 307 from being deformed or damaged by the output shaft 320 that is instantaneously biased in the radial direction by a force that is transmitted through the motor, the worm shaft 303, and the worm wheel 340.

The inner race of the output shaft bearing 307 is axially supported by a lock nut 306 coupled to the outer circumferential surface of the output shaft 320, and the outer race of the input shaft bearing 305 is axially supported by a step of the gear housing 350 that includes a first gear housing 350a and a second gear housing 350b so that the torque sensor 330 and the worm wheel 340 may rotate in the right positions without oscillation or deviation when the input shaft 310 and the output shaft 320 rotate. Accordingly, the torque sensor 330 can conduct an accurate measurement without error, and the worm wheel 340 can more efficiently transmit the auxiliary steering force at the same time.

The support member 309 has a ring shape and has a cut-away portion on one side thereof. The support member 309 is coupled to surround the outer race of the output shaft bearing 307. The inner and outer races of the output shaft bearing 307 are firmly supported by the lock nut 306, the support member 309, and the bearing bracket 351 in the axial and radial directions so that the output shaft 320 and the input shaft 310 are supported on the same axis without oscillation in the right positions, or without deviation from the right positions.

The support member 309 has a large diameter portion 309a that makes contact with the bearing bracket 351 to increase the axial support force thereof. The gear housing 350 has a mounting recess 353 formed therein into which the support member 309 is inserted. An enlarged diameter portion 353a is formed in the mounting recess 353, and the large diameter portion 309a of the support member 309 is inserted into, and axially supported by, the enlarged diameter portion 353a. Accordingly, the support member 309 may support the output shaft bearing 307 in the right position without deviation in the axial direction.

The support member 309 has the large diameter portion 309a on one end of the annular main body 309b and a concave-convex pattern 309c formed on the inner circumferential surface of the main body 309b so that the support member 309 may prevent the output shaft bearing 307 from being separated and slid in the axial direction when the output shaft bearing 307 operates.

As described above, the worm wheel 340 and the torque sensor 330 are coupled to the coupling portion of the input and output shafts 310 and 320 between the output shaft bearing 307 and the input shaft bearing 305, and the output shaft bearing 307 and the input shaft bearing 305 are supported by the first gear housing 350a, the second gear housing 350b, and the bearing bracket 351, which makes it possible to reduce the total volume and weight while preventing the input shaft 310 and the output shaft 320 from oscillating in the right positions or deviating from the right positions.

As described above, according to the present invention, it is possible to enhance the precision of a sensor in the positions to which the worm shaft, the worm wheel, the torque sensor, and the like for providing an auxiliary steering force input from the motor are coupled, and it is possible to reduce the total volume and weight without oscillation or deviation of the input and output shafts in the right positions by preventing the bearings from being deformed and damaged by impacts transmitted to the input and output shafts.

Even if it was described above that all of the components of an embodiment of the present invention are coupled as a single unit or coupled to be operated as a single unit, the present invention is not necessarily limited to such an embodiment. That is, at least two elements of all structural elements may be selectively joined and operate without departing from the scope of the present invention.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present invention expressly defines them so.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

[Description of reference numerals]

| | |
|---|---|
| 303: Worm shaft | 305: Input shaft bearing |
| 306: Lock nut | 307: Output shaft bearing |
| 309: Support member | 310: Input shaft |
| 320: Output shaft | 330: Torque sensor |
| 340: Worm wheel | 350: Gear housing |

What is claimed is:

1. A steering column for a vehicle, comprising:
an input shaft connected with a steering wheel at one end portion thereof, wherein a torque sensor is coupled to the outer circumferential surface of the input shaft;
an output shaft having a worm wheel coupled to the outer circumferential surface of one end portion thereof that is connected with an opposite end portion of the input shaft;
an output shaft bearing coupled to the outer circumferential surface of the output shaft so as to be located adjacent to the worm wheel; and
a support member interposed between the outside of the outer race of the output shaft bearing and a gear housing to support the output shaft bearing in the radial direction.

2. The steering column of claim 1, wherein the outer race of the output shaft bearing and the support member are axially supported by a bearing bracket coupled to the outside of the gear housing.

3. The steering column of claim 2, wherein the inner race of the output shaft bearing is axially supported by a lock nut coupled to the outer circumferential surface of the output shaft.

4. The steering column of claim 3, wherein the support member has a ring shape and is cut away at one side thereof.

5. The steering column of claim 4, wherein the support member has a large diameter portion configured to have an enlarged diameter and to make contact with the bearing bracket.

6. The steering column of claim 5, wherein the gear housing has a mounting recess formed therein into which the support member is inserted, and an enlarged diameter portion is formed in the mounting recess, the large diameter portion being inserted into, and axially supported by, the enlarged diameter portion.

7. The steering column of claim 1, wherein the input shaft has an input shaft bearing coupled to the outer circumferential surface thereof so as to be located adjacent to the torque sensor.

8. The steering column of claim 7, wherein the outer race of the input shaft bearing is axially supported by a step of the gear housing.
